(19) United States
(12) Patent Application Publication
(10) Pub. No.: US 2025/0208835 A1
(43) Pub. Date: Jun. 26, 2025

(54) ENTROPY DIFFERENTIAL EXTRACTOR FROM BARKHAUSEN EFFECT

(71) Applicant: PERISO ShPK, Durrës (AL)

(72) Inventor: Antonio La Gatta, Gandria, Lugano (CH)

(21) Appl. No.: 18/867,105

(22) PCT Filed: May 30, 2022
(86) PCT No.: PCT/EP2022/064597

§ 371 Date: Nov. 19, 2024

Related U.S. Application Data
(60) Provisional application No. 63/343,989, filed on May 19, 2022.

(51) Int. Cl. G06F 7/58; H04L 9/08

(52) U.S. Cl. CPC G06F 7/588; H04L 9/0869

(57) ABSTRACT

Methods and systems for generating entropy and eliminating non-random components of a Barkhausen effect signal are disclosed. In one method, a Barkhausen signal (BS) is captured by applying a changing magnetic field to a ferromagnetic material and measuring a change in magnetic flux. The field is based on an oscillating signal and the BS contains random and non-random components. The BS is converted into a digital data stream and stored in a memory array. A first portion of the data stream is stored as elements in a first memory array and a second portion of the data stream is stored as elements in a second memory array. An element of the first memory array is subtracted from an element of the second memory array. A result of the subtraction is stored that includes the random component of the BS and eliminates the non-random component of the BS.

### BACKGROUND

### Field of the Invention

The present invention relates to generating entropy (random numbers) based on the Barkhausen effect and, more specifically, to a differential extractor for eliminating non-random components of a Barkhausen effect signal.

### Description of Related Art

Most cryptographic applications use random numbers. Correspondingly, cryptographic applications are vulnerable to the quality of the random numbers used. A truly random number generator produces a sequence of numbers that cannot be reasonably predicted better than by random chance. It is often difficult, however, to practically generate random numbers that are truly random. High quality random number generators produce random numbers in a manner that is practically impossible to model. Pseudorandom number generators generate numbers that look random but are in fact pre-determined because they can be reproduced if the state of the pseudorandom number generator is known.

One method for generating high quality random numbers uses the state of an attribute of a physical environment, where the state changes in an unpredictable manner. The best provider of randomness, also called entropy, is based on quantum uncertainty associated with quantum variables. One example of this is the Barkhausen effect.

The Barkhausen effect describes noise in the magnetic output of a ferromagnet when a magnetizing force applied to the ferromagnet is changed. Specifically, the Barkhausen effect is a phenomenon caused by rapid changes in the size of magnetic domains such as atoms in a ferromagnetic material that are magnetically oriented in a similar way. When an external magnetizing field through the ferromagnetic material is changed, the magnetization of the ferromagnetic material changes in a series of discontinuous changes (rather than linearly), causing “jumps” in the magnetic flux through the ferromagnetic material. These jumps, or micro-steps, can be detected by, for example, a coil of wire wound around the ferromagnetic material. The sudden transitions in the magnetic flux of the ferromagnetic material produces current pulses in the coil, which can be detected as a Barkhausen signal (BS) (also referred to as “Barkhausen noise”).

While the amount of entropy in a Barkhausen signal is high, it is not completely random because a Barkhausen signal may be affected by a non-random (recursive) component. Thus, conventional methods for extracting entropy based on the Barkhausen effect produce random numbers that include both a random and a non-random component, which may be undesirable for many applications such as cryptographically securing payment transactions.

Accordingly, a need exists for generating, extracting, or capturing entropy (random numbers) based on the Barkhausen effect and eliminating the non-random components.

### BRIEF SUMMARY

The subject matter described herein includes methods, systems, and computer program products for generating random numbers (entropy) based on the Barkhausen effect including using a differential extractor for eliminating non-random components of a Barkhausen effect signal. According to one method, a Barkhausen signal (BS) is captured by applying a changing magnetic field to a ferromagnetic material and measuring a change in magnetic flux. The changing magnetic field is based on an oscillating signal, such as a square wave, and the BS contains both a random component and a non-random component. The BS is then converted into a digital data stream and the data stream is stored in one of two memory arrays based on the oscillating signal. A first portion of the data stream is stored as one or more elements in a first memory array and a second portion of the data stream is stored as one or more elements in a second memory array. An element of the first memory array is then subtracted from an element of the second memory array, also based on the oscillating signal. A result of the subtraction is then stored, where the result includes the random component of the BS and eliminates the non-random component of the BS.

A system includes a differential extractor for eliminating non-random components of a Barkhausen effect signal includes a Barkhausen inductor for capturing a Barkhausen signal (BS). The BS is captured by applying a changing magnetic field to a ferromagnetic material and measuring a change in magnetic flux. The changing magnetic field is based on an oscillating signal such as a square wave produced by a square wave generator. The BS contains a random component and a non-random component. A digitizing module, such as one or more filters or analog to digital converters, converts the BS into a digital data stream. A memory upside array and a memory downside array alternatingly store the data stream based on the oscillating signal. A first portion of the data stream is stored as one or more elements in the memory upside array. A second portion of the data stream is stored as one or more elements in the memory downside array. An output sampling module subtracts an element of the first memory array from an element of the second memory array based on the oscillating signal. An output memory stores the result of the subtraction, where the result includes the random component and eliminates the non-random component.

### BRIEF DESCRIPTION OF THE SEVERAL VIEWS OF THE DRAWINGS

FIG. 1 is a flow diagram illustrating exemplary steps for generating entropy based on the Barkhausen effect including eliminating a non-random component of a Barkhausen signal according to an embodiment of the subject matter described herein.

FIG. 2 is a system diagram illustrating exemplary components for entropy based on the Barkhausen effect including eliminating a non-random component of a Barkhausen signal according to an embodiment of the subject matter described herein.

FIG. 3 are perspective views of exemplary configurations for a Barkhausen inductor according to an embodiment of the subject matter described herein.

FIG. 4 is a schematic diagram of a low pass filter and a waveform when the filter is applied to a square wave signal according to an embodiment of the subject matter described herein.

### DETAILED DESCRIPTION

The subject matter described herein includes a differential extractor for eliminating nonrandom components of a Barkhausen effect signal. In contrast to conventional methods for generating random numbers, including based on physical phenomena such as the Barkhausen effect, which do not produce truly random numbers because they contain non-random components, the present disclosure generates entropy based on the Barkhausen effect including eliminating nonrandom component(s).

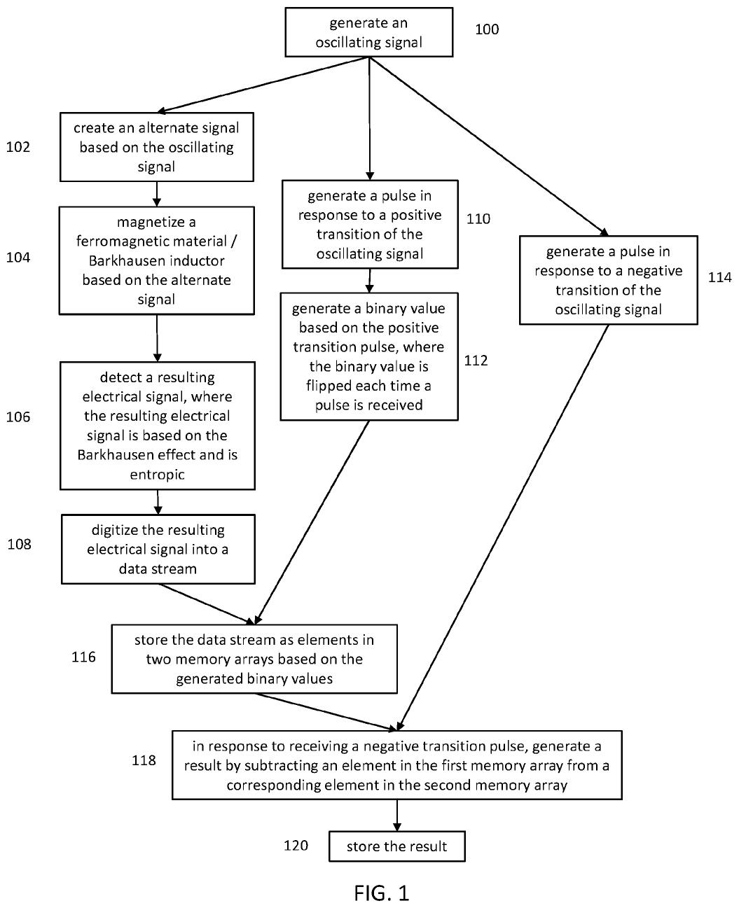

FIG. 1 is a flow diagram illustrating exemplary steps for generating entropy based on a Barkhausen effect signal including eliminating a non-random component associated with the Barkhausen signal according to an embodiment of the subject matter described herein. The process may be performed by one or more hardware or software components configured to extract the entropy associated with the Barkhausen effect and store the entropy in a memory for use in applications such as payment transactions and communications encryption. The process may begin by generating an oscillating signal, such as a square wave. Using at least one coil surrounding a core of a ferromagnetic material, the ferromagnetic core is magnetized and a resulting electrical signal is detected. This signal is digitized and filtered to remove the non-random components of the signal. For example, two memory arrays may store the digitized signal. A sample-by-sample subtraction may be performed on the two memory arrays triggered by a pulse every two integer cycles of the oscillating signal (square wave). In contrast to conventional methods for generating entropy, including methods using the Barkhausen effect, the present invention enhances the randomness produced by eliminating the non-random component of the Barkhausen effect signal.

Referring to FIG. 1, at step 100, the method includes generating an oscillating signal. In one embodiment, generating the oscillating signal includes generating a square wave using a square wave generator (SQW). It is appreciated, however, that any kind of oscillating signal generator may be used. The square wave generator may preferably have a duty cycle associated with maintaining symmetric charge and discharge phases of a Barkhausen inductor (LB). For example, the square wave generator may have a duty cycle of 50 percent.

The square wave generator may have a frequency range based on a magnetic property of a ferromagnetic material of a Barkhausen inductor. In one embodiment, the square wave generator has a frequency range ten times less than a maximum spectrum of a Barkhausen signal produced by the Barkhausen inductor. For example, the square wave generator may have a frequency range between 1 KHz and 1 MHz.

At step 102, an alternate signal is created based on the oscillating signal generated at step 100. In some embodiments, the fast rise time of the square wave may be smoothed to have a more linear rise time. A more linear rise time may be necessary for magnetizing the Barkhausen inductor. For example, smoothing the rise time of the square wave generator may be performed by a low pass filter (LPF). The LPF may be an electrical component or a software module in combination with a digital to analog converter (DAC). The LPF may create an alternate signal used for magnetizing the Barkhausen inductor (LB) in an alternate direction. The goal of the LPF is to produce an output signal with a ramp up and a sub sequential ramp down many times per second. Optimally, the output signal has a perfect linear ramp, but some asymmetry (e.g., 15%) does not undesirably affect performance.

One embodiment, the LPF may include a resistor capacitor (RC) lowpass filter that acts as an integrator. In such an embodiment, a voltage across a bypass capacitor, V(CL), may not be a perfect triangular signal but rather a portion of an exponential loading/deloading RC curve. A typical value for an RC block is hundreds of milliseconds to a microsecond, depending on the output frequency of the square wave generator. Typically, the square wave generator has a frequency range ten times less than a maximum spectrum of the signal (R_{I}·C_{L}˜10/f_{swg}). To make the signal more linear, instead of RL, a constant current generator may be used. Instead of the electrical/hardware-based embodiment above, in a software-based embodiment, an up/down counter coupled with a DAC can provide a triangular output signal.

At step 104, a ferromagnetic material is magnetized based on the signal created at step 102 and, at step 106, an electrical signal resulting from step 104 is detected. As described above, the Barkhausen effect is generated during the magnetization and demagnetization of a ferromagnetic material. The Barkhausen effect may be measured as a random magnetic signal produced by progressive orientation of internal magnetic domain of ferromagnetic material. The random magnetic signal may appear as an electrical signal (Barkhausen signal) across a coil wound around a core of ferromagnetic material. To magnetize, demagnetize, and read the Barkhausen signal, a simple configuration includes a ferromagnetic core and one coil that acts as a both a magnetization coil and as a reader of the resulting Barkhausen signal. Another configuration includes two coils, where one coil is used for magnetizing and demagnetizing the ferromagnetic material and another coil, separate from the first coil, reads the Barkhausen signal.

To reduce the magnetic interference from external magnetic fields, the core of ferromagnetic material can also be implemented as a closed magnetic circuit. For example, a Barkhausen inductor with a toroidal structure may be less susceptible to external magnetic interference.

Applying a changing magnetizing force to the ferromagnet may include magnetizing the ferromagnet for a first polarity, demagnetizing the ferromagnet, and magnetizing the ferromagnet for a second polarity opposite the first polarity (reverse magnetizing). Capturing the resulting Barkhausen signal includes measuring changes in magnetic flux of the ferromagnet. Measuring changes in magnetic flux of the ferromagnet may include detecting a voltage across the Barkhausen inductor (V(LB)), where V(LB) is a result of random variation of voltage across the Barkhausen inductor associated with the Barkhausen effect. It is appreciated that V(LB) is a signal that represents entropy or randomness.

As mentioned above, in one embodiment the Barkhausen inductor includes at least one coil surrounding a ferromagnetic core and the ferromagnetic core has a toroidal structure. In an embodiment where the Barkhausen inductor includes a first coil surrounding the ferromagnetic core, the first coil is configured to magnetize and demagnetize the ferromagnetic core and to measure changes in magnetic flux of the ferromagnetic core. In an embodiment where the Barkhausen inductor includes a first coil and a second coil surrounding the ferromagnetic core, the first coil is configured to magnetize and demagnetize the ferromagnetic core and the second coil is configured to measure changes in magnetic flux of the ferromagnetic core.

At step 108, the electrical signal resulting from step 106 is digitized into a data stream. For example, the data stream may include a sequence of bits, bytes, words, or other similar data structures of data. In one embodiment, digitizing the signal may be performed using a high pass filter (HPF). In another embodiment, digitizing the signal be performed using an analog to digital converter (ADC). For example, a high pass filter is an electrical component or a software module that removes low frequency components from the signal used to magnetize and demagnetize the

LB. The Barkhausen signal is in a higher frequency range, so the HPF extracts spectral components associated with Barkhausen signal. Alternatively, the signal may be digitized by an ADC and then a digital filter may be applied. In yet another alternative, a software module may be used if the signal is already digitized.

At step 110, a pulse is generated in response to detecting a positive transition of the oscillating signal (e.g., square wave) generated at step 100. For example, a positive edge detector (PED) may be configured to generate a pulse in response to detecting a positive transition of the oscillating signal. In one embodiment, the duration of the pulse is about one tenth of the period of the oscillating signal. For example, the duration of the pulse may be between about 100 and 1,000 nanoseconds. Thus, an acquisition time equal to an integer cycle of the SWG includes one positive phase and one negative phase.

At step 112, a binary value (0 or 1) is generated based on the positive transition pulse generated at step 110. The binary value generated at step 112 is flipped (i.e., inverted or reversed) each time a positive transition pulse is received. For example, the binary value may initially be set to 0. When a first positive transition pulse is received at time T1, the binary value may be set to 1. When a second positive transition pulse is received at time T2, the binary value may be set to 0, and so on.

As will be described in greater detail below in step 116, the binary value may be used to redirect the data stream produced at step 108 to one of two memory arrays. For example, if the binary value is 1, then the data stream may be directed to a first memory array until the binary value is 0 when the data stream is redirected to a second memory array.

In addition to generating a positive transition pulse, at step 114, a pulse is generated in response to detecting a negative transition of the oscillating signal (e.g., square wave) generated at step 100. For example, a negative edge detector (NED) may be configured to generate a pulse in response to detecting a negative transition of the oscillating signal. As will be in greater detail below in step 118, this negative transition pulse may be used for triggering a subtraction of values accumulated in the two memory arrays.

At step 116, the data stream is stored as elements in two different memory arrays based on the binary value determined at step 112. In one embodiment, this includes redirecting the data stream from the ADC to a memory array using a controller up-down switch (UDS). For example, the UDS may be configured to redirect the data stream by successively storing the data stream in a first memory array of the two different memory arrays and a second memory array of the two different memory arrays. The first memory array may be a memory upside (MUP) array of length k that is connected to a first output of the UDS. The MUP may be configured to store the data stream starting from an initial location. When the first memory array is filled, the MUP may be configured to overwrite data starting from the initial location. A second memory array of the two different memory arrays may include a memory downside (MDW) array of length k that is connected to a second output of the UDS and configured to store the data stream starting from an initial location and, when the second memory array is filled, overwriting the second memory array starting from the initial location. In another embodiment, the first and second memory arrays (MUP and MDW) may each be shift registers of length k.

At step 118, a result is generated in response to receiving a negative transition pulse generated at step 114. For example, that may include reading, by an output sampling block (SMP), the MUP and the MDW memory arrays in response to receiving the pulse from the NED and subtracting, by the SMP, an element of the MUP memory array with an element of the MDW memory array. It is appreciated that step 118 eliminates all synchronized (non-random) components of the Barkhausen signal by capturing two times the Barkhausen signal in the same condition and subtracting them from each other. The process then repeats, thereby providing a continuous streaming of entropy (sequence of random numbers). It is also appreciated that every couple of SWG integer cycles, the MUP is subtracted from the MDW (or vice versa). Because the negative edge detector produces a pulse for every transition of the binary value, this occurs every two integer cycles of the SWG.

At step 120, the result generated at step 118 is stored. In one embodiment, storing the result includes storing, element by element, the result of the subtraction performed by the SMP in an output memory array (ME).

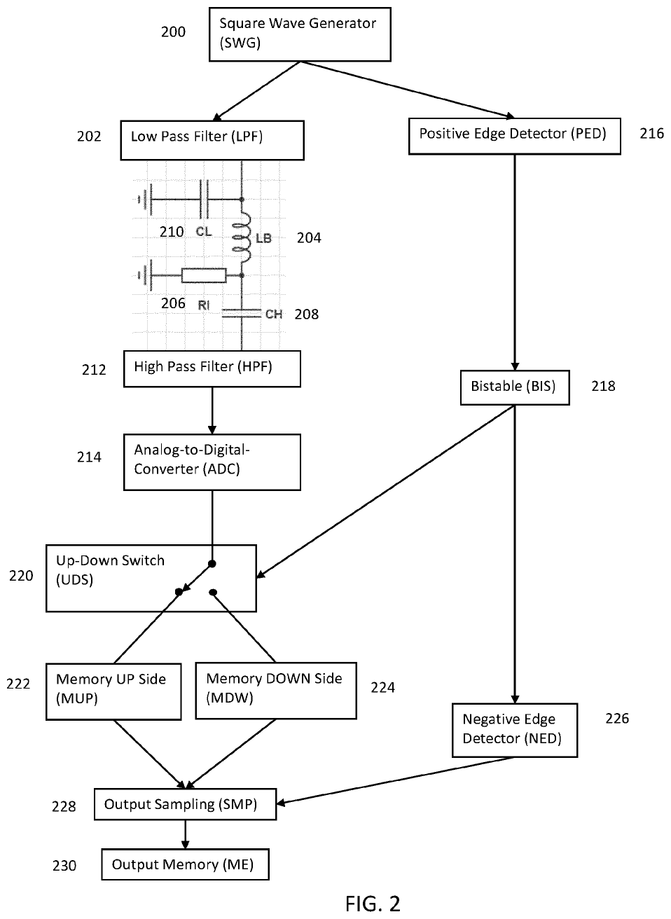

FIG. 2 is a diagram illustrating an exemplary system for generating random numbers (entropy) based on the Barkhausen effect including eliminating a non-random component associated with a Barkhausen signal according to an embodiment of the subject matter described herein. Referring to FIG. 2, square wave generator (SWG) 200 may include an electrical oscillator with a duty cycle of 50%. The duty cycle may be configured to ensure that successive charge and discharge phases of the LB 204 are symmetric. A typical value of SWG 200 frequency, f_{swg}, may be in the range of 1 KHz and 1 MHz, but can be vary according to a magnetic property of LB 204. In one embodiment, the frequency range of the oscillator 200 may be 10 times less than the maximum spectrum of Barkhausen signal produced by LB 204.

The output of SWG 200 may be received, as input, by a low pass filter (LPF) 202. The LPF 202 may be an electrical component, or a software module in combination with a DAC (digital to analog converter) 214. The LPF 202 may be configured to create an alternate signal used for magnetizing the LB 204 in alternate directions. A goal of LPF 202 is to produce an output signal with ramp up and sub sequential ramp down many times per second. A perfect linear ramp may be optimal, but including some asymmetry (e.g., on the order of 15%) does not affect the performance too much. One implementation includes a RC lowpass filter that acts as an integrator. In this implementation, V(C_{L}) is not a perfect triangular signal but a portion of exponential loading/deloading RC curve. To make the signal more linear, instead of R_{L}, a constant current generator may be used. Alternatively, an embodiment using a combination of software and an up/down counter coupled with DAC (digital to analog converter) may also provide a triangular output signal. A typical value for a RC block may be hundreds of milliseconds to a microsecond, depending on the SWG output frequency. Typically, R_{I}·C_{L}˜10/f_{swg}.

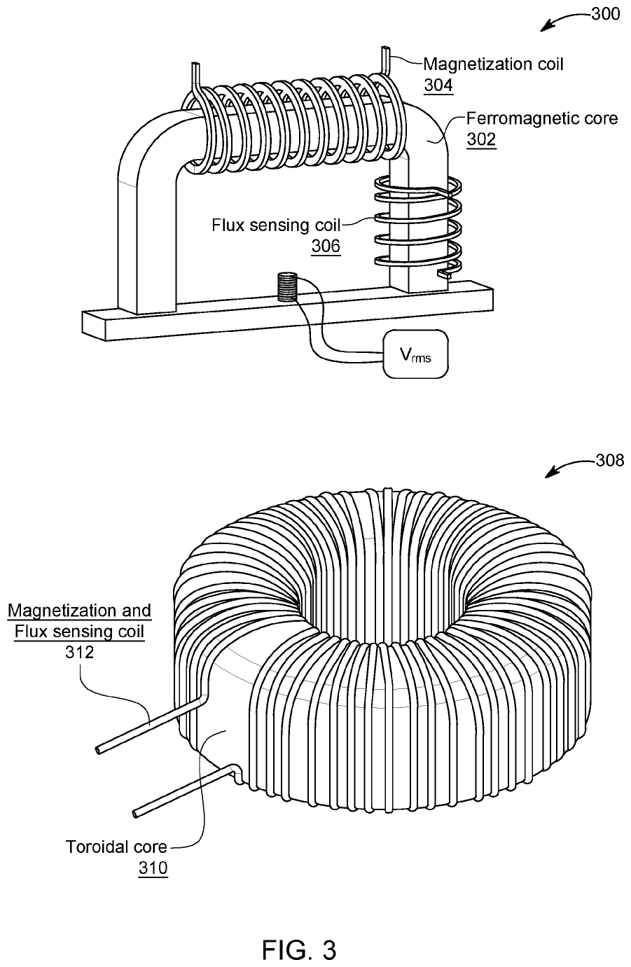

Barkhausen inductor (LB) 204 may be an electrical component. The Barkhausen effect is generated during the magnetization and demagnetization of ferromagnetic material. In other words, a core ferromagnetic material (FMM) may produce a random magnetic signal produced by progressive orientation of internal magnetic domain of FMM. This random magnetic signal may be detected or measured as an electrical signal across a coil turned around the FFM. As will be described in greater detail with respect to FIG. 3, in order to magnetize, demagnetize, and read the Barkhausen signal, a simple configuration includes one coil that act as magnetization coil but also as reader of Barkhausen signal. Another possible configuration is a ferromagnetic core that, instead of one coil, has two coils, where one coil is used to magnetize and demagnetize the ferromagnetic material and another coil reads the Barkhausen signal. To reduce the magnetic interference from external magnetic field, the core of ferromagnetic material can also be implemented as a closed magnetic circuit, such as a toroidal structure, which may be less susceptible to external magnetic interference.

Current detector (RI) 206 is an electrical component. The random signal (the Entropy) generated by LB 204 during the magnetization and demagnetization process is a voltage V(LB) across LB 204. This voltage V(LB), added to V(CL), is measurable across RI 206 as V(RI). In other words, the RI 206 acts as current detector of a signal resulting from V(CL)+V(LB).

Decoupling capacitor (CH) 208 is an electrical component or a software module. The signal across RI(V(RI)) can have a strong DC (direct current) component. CH 208 eliminates the direct current (DC) components so that the input signal of HPF (VIhpf) is zero average signal: |VIhpf|=0. Alternatively, the signal V(RI) can be digitally sampled by an ADC 214, and the functionality of CH 208 can be emulated by software with the following operation: VIhpf=V(Ri)−|V(Ri) |. In an embodiment where the component following HPF 212 is hardware-based, CH 208 may not be necessary because a smaller capacitance may already be present at the input stage of HPF 212 and, as a result, CH 208 can be eliminated.

Bypass capacitor (CL) 210 is an electrical component. The Barkhausen effect results from random variation of voltage across LB, V(LB), which is a signal that represent the entropy to be extracted. CL bypass capacitor 210 bypasses to ground the current that in otherwise would be redirected to LPF 202. As a result of the CL bypass effect, a stronger signal will be extracted on RI 206. In other words, because most of power spectral density (PSD) of a Barkhausen effect signal is in the high frequency range and, from high frequency standpoint, CL 210 has a very low reactance, most of Barkhausen signal will be present on RI 206. The voltage across CL 210, V(CL), changes slowly with respect to the high frequency random signal produced by LB 204 (V(LB)). Based on a typical maximum driving current of LPF 202, CL 210 can have a capacitance in the range of few nano Farads to a few micro Farads.

High pass filter (HPF) 212 is an electrical component or a software module that removes low frequency components from the signal used to magnetize and demagnetize LB 204. The signal of Barkhausen effect is locate in high frequency so HPF 212 will extract the sole spectral components associate to Barkhausen signal. The cut off frequency fhpf is strongly dependent to SWG frequency fswg and must be at least 10 times it: fhpf>10 fswg. HPF 212 can be implemented by a first order RC (or above order) and also by an LR filter. One alternative is to implement HPF 212 in software if the signal is already digitized or digitizing the signal using ADC 214 and then applying a digital filter.

Analog to digital converter (ADC) 214 is an electrical block that converts an analog signal into a digital signal. ADC 214 may only be necessary if the signal was not already digitalized by HPF 212 as described above. The output of ADC 2114 may include a data stream (e.g., bytes, or words if more than 8 bits). The data stream may have a sampling rate frequency fadc. The data stream is successively stored in two different memory arrays, MUP 222 and MDW 224, depending on which memory array is selected by UDS 220. In addition to receiving the data stream from ADC 214 as input, UDS 220 also receives a positive transition pulse.

Positive edge detector (PED) 216 is an electrical block or software block that receives in input a square signal and outputs a pulse upon detecting a rise time (positive transition) of input. The duration of the output pulse is typically one tenth of input period and is used as input for a monostable block that flips a binary value at every pulse. A typical duration of the output pulse is hundreds of nano seconds.

Bistable (BIS) 218 is an electrical component or a software module that flips the output of a binary value (i.e., between 0 and 1) every time an input pulse is received. BIS 218 can be implemented with a logical divisor by two. For example: T Flip flop or D flip flop with feedback. Alternatively, it can be implemented as a software module. Alternatively it can be implemented with a RC high pass filter where the time constant T_{d}=R_{d}·C_{d} is at least one order less than the period of input Pᵢ: T_{d}<<Pᵢ.

Up-Down switch controller (UDS) 220 is typically a software module but can be implemented also as hardware analog switch. In an embodiment where the UDS 220 is a hardware component, two ADCs 214 may be used where one ADC 214 is used for each memory MUP 222 and MDW 224. UDS 220 may be configured to direct or redirect the data stream from ADC 214 to one of two memory arrays, MUP 222 or MDW 224 depending on the output of BIS 218. For example, if the output is 1, the data stream will be redirected to MUP 222 and, if the output is 0, the data stream will be redirected to MDW 224.

Memory upside (MUP) 222 is designed to store, in an array of length k, the data stream of bytes from UDS 220. After array 222 is filled with k elements, subsequent elements will overwrite past elements starting from the initial location. Alternatively, MUP 222 can be implemented as shift register of length k.

Memory downside (MDW) 224 is equivalent to MUP 222 but is connected to a different output of UDS 220. MDW 224, therefore, is designed to store, in an array of length k, the data stream of bytes from UDS 220. After array 224 is filled with k elements, subsequent elements will overwrite past elements starting from the initial location. Alternatively, it can be implemented as shift register of length k.

Negative edge detector (NED) 226 is an electrical block or software block that receives in input a square signal and gives in output a short pulse only during the rise time (positive transition) of input. The duration of output pulse is typically one tenth of input period and it is used for feeding a monostable block that flips every pulse. A typical duration of the output pulse is hundreds of nano seconds.

Output sampling block (SMP) 228 is an electrical component or a software module that includes: a trigger input (from NED 226), two memory array inputs (MUP 222 and MDW 224), and one memory array output (ME 230). After a pulse is received, as trigger input, from the NED 226, SMP 228 reads the memory arrays MUP 222 and MDW 224, subtracts an element of MUP 222 from an element of array MDW 224, and stores the result, element by element, in the array ME 230. Formally:

Assuming:
kᵤ is the length of array MUP 222
k_{d} is the length of array MDW 224, and
kₑ the length of array ME, where kᵤ=k_{d}=kₑ=k, and further assuming:
Kmup[n] the element “n” of array MUP
Kmdw[n] the element “n” of array MDW
Kme[n] the element “n” of array ME, then after the trigger:
Kme[n]=Kmup[n]−Kmdw[n] for every 0≤n≤k

Output memory (ME) 230 is an array memory with same length (e.g., k) of MUP 222 and MWD 224. ME 230 is filled by SMP 228 as described above (i.e., ME 230 will be filled with difference of MUP 222 and MDW 224). Formally, ME 230 will contain, for each element, the value Kme[n]=Kmup[n]−Kmdw[n] for every 0≤n≤k. ME 230, therefore, contains the entropy (randomness) extracted from the Barkhausen signal and can be used for a variety of quantum processed that need a data stream of true random numbers.

FIG. 3 are perspective views illustrating exemplary configurations of a Barkhausen inductor for generating a Barkhausen effect signal according to an embodiment of the subject matter described herein. Referring to FIG. 3, a first embodiment 300 of a Barkhausen inductor includes a ferromagnetic core 302 surrounded by a magnetization coil 304 and a flux sensing coil 306. As described previously, capturing a resulting Barkhausen signal includes applying a changing magnetizing force to the ferromagnet and measuring changes in magnetic flux of the ferromagnet. The measured voltage across the Barkhausen inductor (V(LB)), where V(LB) is a result of random variation of voltage across the Barkhausen inductor associated with the Barkhausen effect is a signal that represents entropy or randomness.

A second embodiment 308 includes a toroidal ferromagnetic core 310 surrounded by a single magnetization and flux sensing coil 312. As mentioned previously, the coil 312 is configured to magnetize and demagnetize the ferromagnetic core and to measure changes in magnetic flux of the ferromagnetic core. The toroidal core 310 may be less susceptible to external magnetic interference than ferromagnetic core 302.

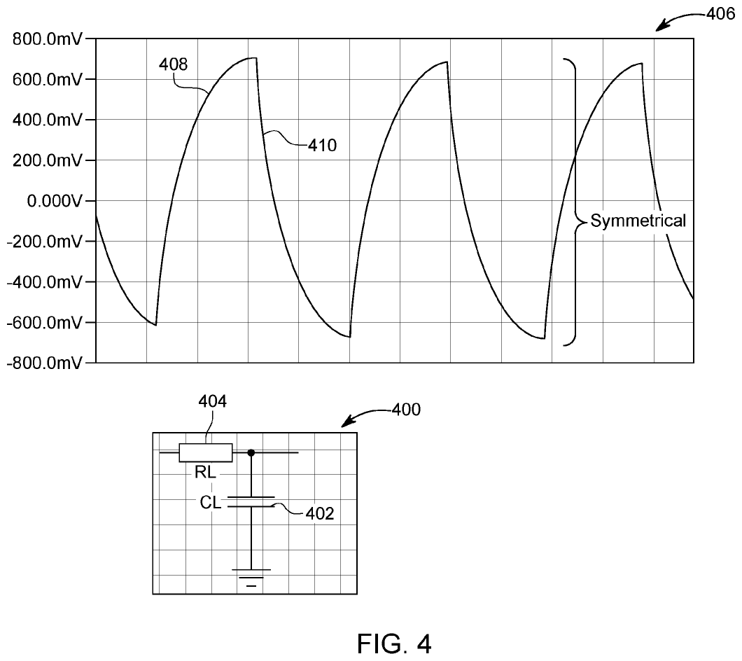

FIG. 4 is a schematic diagram of a low pass filter and a resulting waveform when applied to a square wave generator signal according to an embodiment of the subject matter described herein. Referring to FIG. 4, LPF circuit 400 may include a capacitor 402 and a current detector 404 in the configuration shown. When circuit 400 is applied to a square wave, the fast rise time of the square wave is smoothed to have a more linear rise time, as shown in waveform 406. LPF circuit 400 acts as integrator providing a ramp up voltage to the Barkhausen inductor. The signal rises during the positive phase 408 of the square wave and the signal falls during the negative phase 410 of the square wave. It is also appreciated that the square wave generator preferably has a duty cycle associated with maintaining symmetric charge and discharge phases of a Barkhausen inductor (LB), such as a duty cycle of 50 percent. This symmetry is shown in waveform 406 where the maximum is approximately 700 mV and the minimum is approximately-700 mV.

It is appreciated that the result is a random number with high entropy and may be used in a variety of applications. For example, the random number stored at step 120 may be used to perform an electronic payment transaction or as an encryption key for securing electronic communications.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
capturing a Barkhausen signal (BS) based on applying a changing magnetic field to a ferromagnetic material and measuring a change in magnetic flux, wherein the changing magnetic field is based on an oscillating signal and wherein the BS contains a random component and a non-random component;
converting the BS into a digital data stream;
storing the data stream in one of two memory arrays based on the oscillating signal, wherein a first portion of the data stream is stored as one or more elements in a first memory array and a second portion of the data stream is stored as one or more elements in a second memory array;
subtracting an element of the first memory array from an element of the second memory array based on the oscillating signal; and
storing a result of the subtraction, wherein the result includes the random component and eliminates the non-random component.

2. The method of claim 1, wherein the oscillating signal is a square wave.

3. The method of claim 2, wherein the square wave is configured to maintain symmetric charge and discharge phases of a Barkhausen inductor.

4. The method of claim 2, wherein the square wave has a frequency range between 1 KHz and 1 MHz.

5. The method of claim 2, wherein the square wave has a frequency range ten times less than a maximum spectrum of the BS.

6. The method of claim 2, further comprising smoothing a rise time of the square wave.

7. The method of claim 1, wherein applying a changing magnetizing force to the ferromagnet includes magnetizing the ferromagnetic material for a first polarity and demagnetizing the ferromagnet.

8. The method of claim 1, further comprising reverse magnetizing the ferromagnetic material, wherein reverse magnetizing includes magnetizing the ferromagnet for a second polarity opposite the first polarity.

9. The method of claim 1, wherein measuring changes in magnetic flux of the ferromagnetic material includes detecting a voltage resulting from random variation of voltage associated with a Barkhausen effect.

10. The method of claim 1, wherein the Barkhausen inductor includes at least one coil surrounding a ferromagnetic core.

11. The method of claim 10, wherein the ferromagnetic core has a toroidal structure.

12. The method of claim 10, wherein a Barkhausen inductor includes a first coil surrounding the ferromagnetic core, wherein the first coil is configured to magnetize and demagnetize the ferromagnetic core and to measure changes in magnetic flux of the ferromagnetic core.

13. The method of claim 10, wherein the Barkhausen inductor includes a first coil and a second coil surrounding the ferromagnetic core, wherein the first coil is separate from the second coil, wherein the first coil is configured to magnetize and demagnetize the ferromagnetic core and the second coil is configured to measure changes in magnetic flux of the ferromagnetic core.

14. The method of claim 1, wherein a first memory array of the two memory arrays includes a memory upside (MUP) of length k that is connected to a first output and configured to store the digital data stream starting from an initial location and, when the first memory array is filled, overwriting the first memory array starting from the initial location.

15. The method of claim 1, wherein a first memory array of the two memory arrays includes a shift register of length k.

16. The method of claim 1, wherein a second memory array of the two memory arrays includes a memory downside (MDW) of length k that is connected to a second output and configured to store the digital data stream starting from an initial location and, when the second memory array is filled, overwriting the second memory array starting from the initial location.

17. The method of claim 1, wherein a second memory array of the two memory arrays includes a shift register of length k.

18. The method of claim 1, further comprising:
generating, by a positive edge detector (PED), a pulse in response to detecting a positive transition of the oscillating signal; and
generating, by a negative edge detector (NED), a pulse in response to detecting a negative transition of the oscillating signal.

19. The method of claim 18, wherein the duration of the pulse is about one tenth of the period of the oscillating signal.

20. The method of claim 18, further comprising:
receiving a sequence of pulses from the PED; and
in response receiving each of the pulses, generating a binary output value that is opposite a previous binary output value.

21. The method of claim 20 wherein storing the result includes storing, element by element, in an output memory array (ME).

22. The method of claim 1, wherein the result is used to perform an electronic payment transaction.

23. The method of claim 1, wherein the result is used as an encryption key for securing electronic communications.

24. A system comprising:
a Barkhausen inductor for capturing a Barkhausen signal (BS) based on applying a changing magnetic field to a ferromagnetic material and measuring a change in magnetic flux, wherein the changing magnetic field is based on an oscillating signal and wherein the BS contains a random component and a non-random component;
a digitizing module for converting the BS into a digital data stream;
a memory upside array and a memory downside array for storing the data stream based on the oscillating signal, wherein a first portion of the digital data stream is stored as one or more elements in the memory upside array and a second portion of the data stream is stored as one or more elements in the memory downside array;
an output sampling module for subtracting an element of the memory upside array from an element of the memory downside array based on the oscillating signal; and
an output memory for storing a result of the subtraction, wherein the result includes the random component and eliminates the non-random component.
